(19) United States
(12) Patent Application Publication
(10) Pub. No.: US 2004/0181809 A1
(43) Pub. Date: Sep. 16, 2004

(54) Television via telephone using spread-spectrum modulation

(76) Inventor: Donald L. Schilling, Palm Beach Gardens, FL (US)

Correspondence Address: DAVID NEWMAN CHARTERED, Centennial Square, P.O. Box 2728, La Plata, MD, 20646-2728, US

(21) Appl. No.: 10/386,405

(22) Filed: Mar. 11, 2003

(51) Int. Cl. H04N 7/173

(52) U.S. Cl. 725/98; 725/87; 725/95; 725/122

(57) ABSTRACT

An improvement to a telephone system using a Digital Subscriber Loop (DSL). A second broadband-data signal, which may be a computer signal, a television signal, or other broadband or video signal, is encoded, for overlaying the first broadband-data signal, in one of four or more bands. The encoding multiplies the second broadband-data signal by an encoding signal. The encoding signal typically includes a Walsh function. The encoded-second broadband-data signal is transmitted, at a respective carrier frequency for one of the four or more bands, over a DSL communications channel. At a remote subscriber unit, the encoded-second broadband-data signal is decoded. A respective replica of the encoding signal, as used for the encoding, decodes the encoded-second broadband-data signal. The decoded-second broadband-data signal is converted to the second broadband-data signal.

### BACKGROUND OF THE INVENTION

This invention relates to television and computer signals, and more particularly to increasing capacity by sending television and computer signals over telephone lines using spread-spectrum modulation.

### DESCRIPTION OF THE RELEVANT ART

Cable, used for cable television (TV), has a bandwidth of at least 750 MHz. At present, cable television systems can receive 250 or more programs, which are broadcast simultaneously over the cable. A television receiver also can receive TV programs, as TV signals, over a telephone line, with comparable quality to that received by cable systems. The telephone line, however, when using ADSL, today, has a limited download bandwidth of approximately 6 MHz, and therefore, only four channels can be broadcast simultaneously, using current technology. However, a TV receiver can be connected to a telephone jack, with appropriate TV service into the telephone jack, and receive any desired TV signal if the program were sent on demand and not broadcasted.

Present TV through a telephone system has limited capacity. In the United States, for example, the telephone systems, using ADSL, have available TV bandwidth of approximately 6 MHz. Typically, the 6 MHz is divided into four bandwidths of 1.5 MHz for each bandwidth. The 6 MHz available bandwidth is in addition to the 0-4 kHz bandwidth used for analog voice, and 25-160 kHz band used for transmission from the user to the end office to provide interactive service. The four bandwidths are referenced, or indexed, throughout this patent as bands A, B, C, D, respectively. DSL technology exploits the 6 MHz available bandwidth to carry information, the TV signals, without disturbing the ability of the telephone line to carry conversations.

A TV signal sent through one of the four available bandwidths has comparable quality to a TV signal sent over a cable system. A TV signal, however, requires an entire bandwidth when being sent to a TV receiver. In the broadcast mode, with four available bandwidths, a TV receiver system simultaneously may receive up to four TV signals, at a given time. The currently available four TV bandwidths limits capacity for sending more than four TV signals at a time. Thus, today, using on-demand technology, only four TV sets, each using a special set-top box, can be connected to the telephone jacks, allowing a full range of different TV programs to be viewed on each TV set, provided that the end office is set up for on-demand service.

### SUMMARY OF THE INVENTION

A general object of the invention is to receive all TV signals, or programs, at a telephone central office, and from the telephone central office, to only transmit a TV program, to a subscriber, that is requested by that subscriber. Such a subscriber requested system provides on-demand service.

Another object of the invention is to increase available capacity for sending TV signals over a telephone system.

An additional object of the invention is to transmit a requested TV program to a subscriber, via standard telephone lines, using asymmetric DSL (ADSL).

A further object of the invention is to use spread-spectrum modulation to increase the effective capacity of the available bandwidth, which is typically considered to be 6 MHz, thereby increasing significantly, the number of distinct users that can simultaneously receive different TV programs, or receive high-speed Internet access, from a single DSL line.

According to the present invention, as embodied and broadly described herein, an improvement to a telephone system using a Digital Subscriber Loop (DSL) is provided. The telephone system is assumed to have four bands, with each of the four bands having a bandwidth of approximately 1.5 MHz. Only one band, however, is required, and there may be more than four bands. The bandwidth may be less than or larger than the assumed 1.5 MHz. Each band is for transmitting a first broadband-data signal. The first broadband-data signal may be a computer signal, a television signal, or other broadband or video signal. The first broadband-data signal is assumed to already be transmitted, over the band, without the improvements of the present invention.

The improvement includes encoding a second broadband-data signal, for overlaying the first broadband-data signal, in one or more of the four bands. The second broadband-data signal may be a computer signal, a television signal, or other broadband or video signal. The second broadband-data signal is encoded by multiplying the second broadband-data signal by an encoding signal. The encoding, as used herein, may be considered spreading as a form of spread-spectrum modulation. The encoding signal has a first Walsh function g₁(t), a second Walsh function g₂(t), a third Walsh function g₃(t), or a fourth Walsh function g₄(t). Other orders of Walsh functions may be used, especially for wider bandwidth channels. Other orthogonal or quasi-orthogonal encoding signals may be employed, with possible degradation in performance.

The encoded-second broadband-data signal is transmitted, at a respective carrier frequency for one of the four bands, over a DSL communications channel.

At a remote subscriber unit (RSU), the encoded-second broadband-data signal is decoded. A respective replica of the encoding signal, as used for the encoding, decodes the encoded-second broadband-data signal, thereby generating a decoded-second broadband-data signal. The decoded-second broadband-data signal is converted to the second broadband-data signal.

The improvement to a telephone system using a Digital Subscriber Loop, may be extended to a plurality of broadband-data signals. Accordingly, a plurality of broadband-data signals are encoded, for overlaying the first broadband-data signal, by multiplying the plurality broadband-data signals by a plurality of encoding signals having a first Walsh function g₁(t), a second Walsh function g₂(t), a third Walsh function g₃(t), or a fourth Walsh function g₄(t), respectively. The encoded-plurality of broadband-data signals is transmitted, at a respective carrier frequency for one of the four bands, over a DSL-communications channel. The four, or more, second broadband-data signals also could each be encoded by the second Walsh function, g₂(t); the four, or more, third broadband data signals could each be encoded by the third Walsh function g₃(t); etc. In general, each broadband-data signal, in the same frequency band, must be encoded by a different Walsh function.

The encoded-plurality of broadband-data signals are decoded, using respective replicas of the plurality of the encoding signals, as used for encoding the plurality of broadband-data signals. The plurality of decoded-second broadband-data signals are converted to the plurality of broadband-data signals, respectively.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 is a block diagram of a DSL system;

FIG. 2 illustrates available bandwidth over a telephone line employing ADSL;

FIG. 3 is a block diagram of a video switch at the telephone central office;

FIG. 4 shows a packet;

FIG. 5 illustrates four bandwidths A, B, C, D;

FIG. 6 shows several remote subscriber units (RSU);

FIG. 7 shows spreading waveforms following the Walsh functions (Hadamard sequences);

FIG. 8 illustrates a receiver;

FIG. 9 is a block diagram of a QAM generator;

FIG. 10 is a block diagram for generating synchronizing signals and carrier frequencies; and

FIG. 11 shows timing of a symbol, and Walsh functions g₁(t) and g₄(t).

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

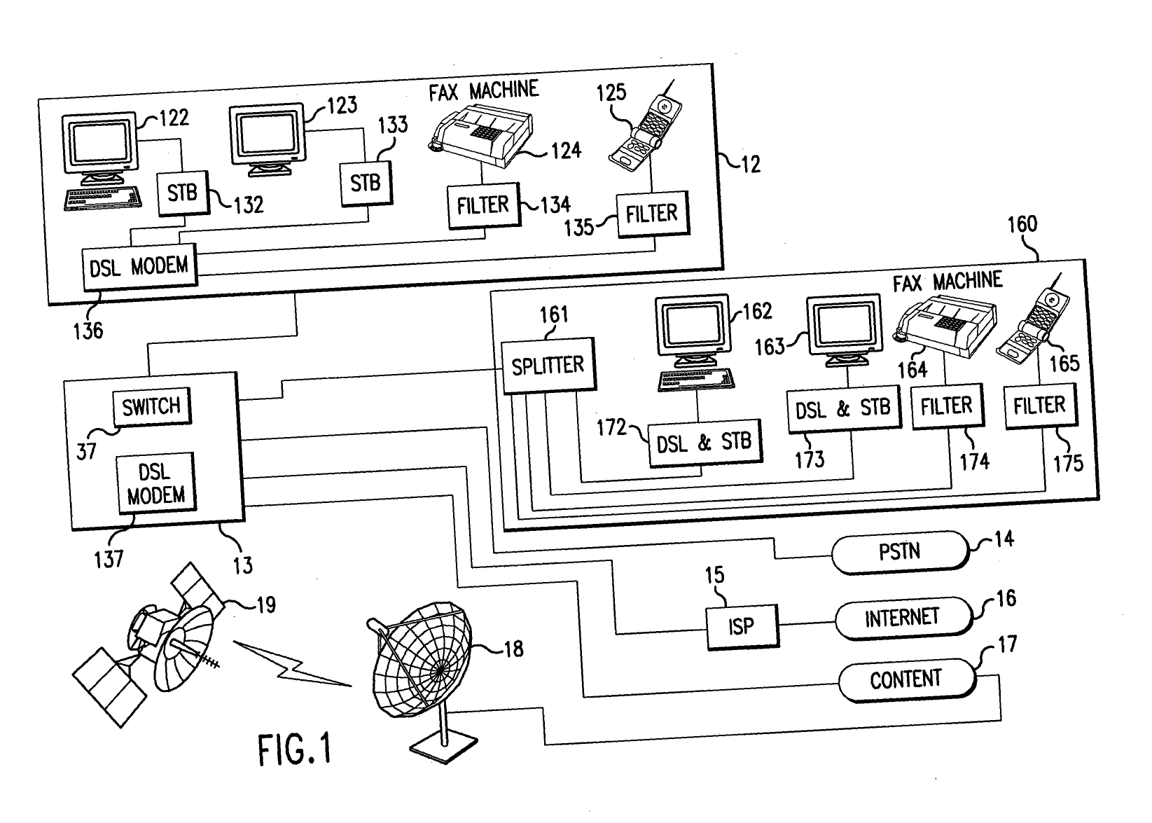

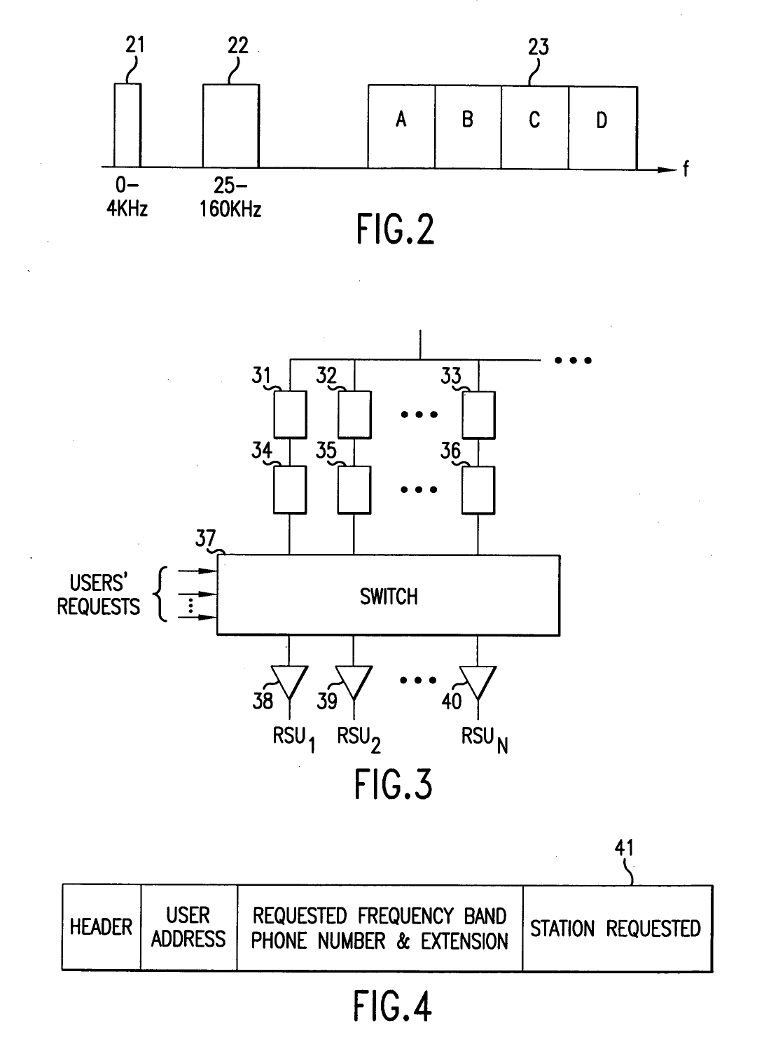

The present invention provides a novel approach to increasing the effective capacity for transmitting broadband signals over a twisted pair, Digital Subscriber Loop (DSL) system. As illustratively shown in FIG. 1, a DSL system delivers broadband signals from a central office 13, using a DSL modem 137, to a home 12, 160, or equivalent user such as an office. A central office might take a 6 MHz television (TV) signal, and using compression technology, compress the signal by one-half, if MPEG-2 were used. The compressed signal may be forward-error-correction (FEC) encoded, using, for example, a rate 3/4 code. The FEC-compressed signal then might be transmitted over the DSL system using 256 quadrature-amplitude modulation (256 QAM). The resulting bandwidth would be one-half Mega-Hertz (0.5 MHz). This signal would be transmitted, as shown in FIG. 2, in one of four bands 23, which are labeled A, B, C, D, respectively, from the central office 13 to the home 12, and received by a DSL modem 121. Each of the four bands might have 1.5 MHz available spectrum. In general, N bands could be used in lieu of the 4 bands, in which each band would have a bandwidth, BT/N, where BT is the total bandwidth available in the DSL system. In the present example BT=6 MHz. At the home 12, a computer 122 connected through a set-top box 132, a television 123 connected through a set-top box 133, a facsimile machine 124 connected through a filter 134, telephone 125 connected through a filter 135, or other equipment, may be attached to the DSL modem 136 and receive a respective signal. This type of mode is similar to a private branch exchange. Alternatively, at a home 160, a computer 162 connected through a modem and set-top box 172, a television 163 connected through a DSL modem and set-top box 173, a facsimile machine 164 connected through a filter 174, a telephone 165 connected through a filter 175, or other equipment, may be to a power splitter 161 and receive a respective signal. The available DSL-spectrum on a twisted pair, as shown in FIG. 2, includes an initial bandwidth 21 for typically analog voice, but digital voice or other narrowband signals, such as facsimile, may be sent within the initial bandwidth. Also included is a second bandwidth 22 which can be used for sending computer data, or a request for a particular video program, etc., to the central office 13.

The present invention encodes, or spreads, a plurality of broadband-data signals in bands A, B, C, D, using one of four, or more, Walsh functions, also known as Hadamard sequences. Other orthogonal or quasi-orthogonal sequences could be used.

The central office 13 is connected to the home, typically through fiber optic cable and then twisted pair. The fiber optic cable might go to a proximity of a number of homes, with distribution to the home from a junction box, through twisted pair, as is well-known in the art. In urban and suburban areas, however, where the central officer is within one or two miles from the farthest residence, fiber often is not used.

The central office 13 typically is connected to a PSTN 14, the Internet 16 through an Internet service provider 15, and a source of content 17, which may be from a ground station 18 communicating with a satellite 19, cable, or other sources, as is well-known in the art. The central office 13 may provide content, such as a TV program or a video on demand program, from compact disk, or other storage medium.

Thus, the bandwidth of a TV signal is reduced by using video compression, such as MPEG, and high-level QAM, such as 256 QAM. Using signals having ordinary pseudo-noise sequences to spread this signal causes a very small eye and makes the signal very sensitive to thermal noise, multipath noise and other noises.

The central office includes a switch 37, as shown in FIG. 3. The switch receives all programming content from satellite, cable, etc., through a plurality of receivers 31, 32, 33. The programming content also may be stored in a central office library. A plurality of transmitters 34, 35, 36 may digitize, FEC encode and, in general, process the content as needed, for transmission to a plurality of remote-subscriber units RSU₁, RSU₂, RSU_{N}. For an already digitized signal, the plurality of transmitters 34, 35, 36 may FEC encode and, in general, process the content as needed, for transmission to a plurality of remote-subscriber units RSU₁, RSU₂, RSU_{N}. A plurality of amplifiers 38, 39, 40 amplify content which goes to a respective remote-subscriber unit. The switch 37, which is connected between the plurality of transmitters 34, 35, 36 and the plurality of amplifiers 38, 39 40, processes users' requests, to direct content to an appropriate remote-subscriber unit RSU₁, RSU₂, RSU_{N}. A remote-subscriber unit might send a packet 41 of FIG. 4, having, as required, a header, user address, requested frequency band, subscriber's phone number and extension, and/or station or content requested. Alternatively, the frequency band might be decided by the end office.

FIG. 5 illustrates the four bands, each with a bandwidth BW approximately equal to the inverse of the symbol time, 1/T_{S}, where T_{S} is the symbol time. The symbol time is the fundamental time duration of the Walsh functions and is discussed in detail, below. Typically the bandwidth of the inverse symbol time T_{S} is equal to the minimum bandwidth B_{T} in one band.

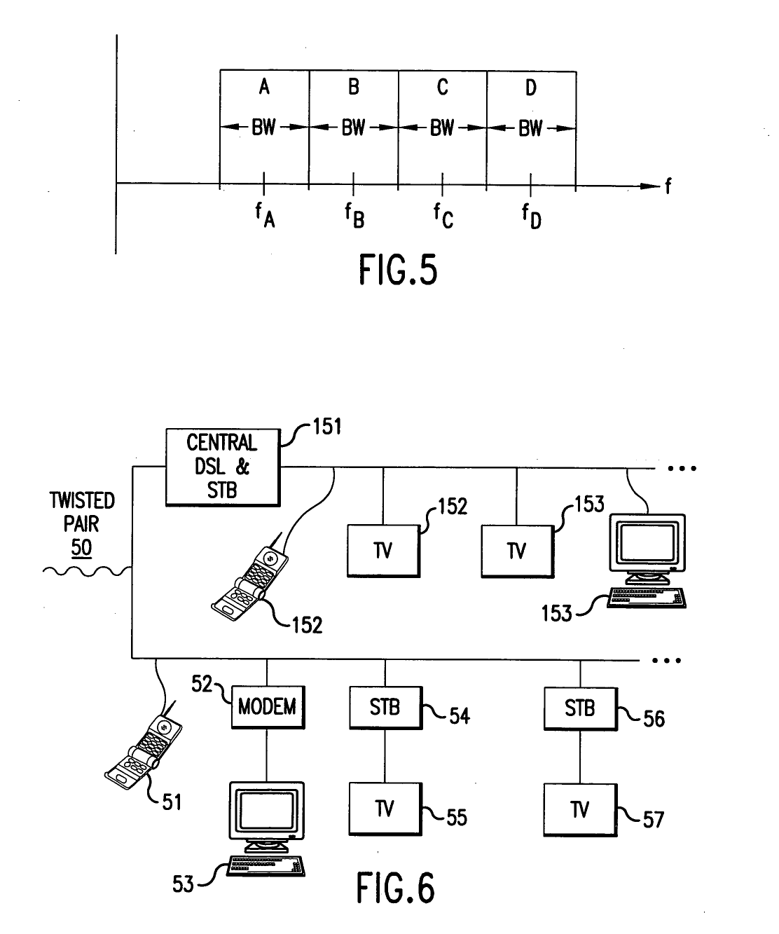

At a remote-subscriber unit, as shown in FIG. 6, a twisted pair 50 from a central office 13 or equivalently a head-end office, is connected to a telephone, 51, through a modem 52 to a computer 53, and a plurality of set-top boxes 54, 56 to a plurality of televisions 55, 57, respectively. Alternatively, at a remote-subscriber unit, the central office 13 or equivalently a head-end office, is connected through a central DSL modem and set-top box 151 located at the remote subscriber, to a telephone 152, to a computer 153, and a plurality of televisions 155, 157. The filters used in FIG. 1, filter the spectrum 21 of FIG. 2, with the useable frequencies 0-4 kHz as an output. Such filters are well-known in the art.

Regular television is broadcast. Cable TV is broadcast. DSL TV is on-demand, that is, the user requests a program. In current on-demand DSL systems, up to four TV or computer signals simultaneously can be sent, each in one of the four bands 23. The present invention allows 20 or more TV or computer signals, or, more generally, broadband-data signals, to simultaneously be transmitted on one set of twisted pair.

The present invention provides an improvement to a telephone system using a DSL system. The DSL system has four or more bands, with each of the four or more bands having a bandwidth, typically 1.5 MHZ. The bandwidth may be more or less than 1.5 MHz. Each band is for transmitting a first broadband-data signal, which may be a computer, television, or video signal. The first broadband signals are assumed to be one or more of the already existing signals sent via the presently existing DSL system. The present invention contemplates using, but modifying, the already existing central office and remote-subscriber unit (RSU).

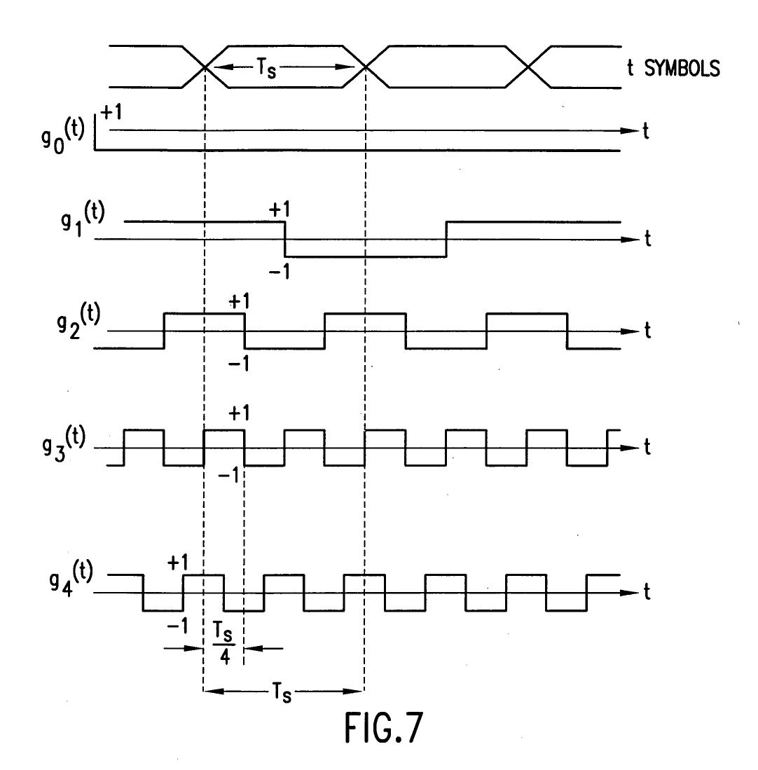

The central office 13 encodes a second broadband-data signal, for overlaying the first broadband-data signal, within the bandwidth, in one of the four or more bands 23. The encoding includes multiplying, or equivalent electronic operation, the second broadband-data signal by an encoding signal having an orthogonal or quasi-orthogonal function. In a preferred embodiment of the present invention, the orthogonal functions would include a first Walsh function g₁(t), a second Walsh function g₂(t), a third Walsh function g₃(t), or a fourth Walsh function g₄(t), as shown in FIG. 7. The resulting encoded signal is referred to herein as an encoded-broadband-data signal. A transmitted symbol is constant during the time Tₛ. The signal formed by the product of the Walsh signal and the information symbol has an average value of zero. The product of two different Walsh signals, when averaged over the duration T_{S} of a symbol, is also equal to zero. The central office transmits the encoded-broadband-data signal, at a respective carrier frequency for one of the four or more bands, over a DSL-communications channel. Broadband signals transmitted in the same band, for example, band A, must be encoded using different Walsh functions, so that they are orthogonal.

At a home 12, a remote-subscriber unit decodes the second encoded-broadband-data signal. The decoding uses a respective replica of the encoding signal having, as used by the central office for encoding, the corresponding orthogonal or quasi-orthogonal functions. Preferably the first Walsh function g₁(t), second Walsh function g₂(t), third Walsh function g₃(t), or fourth Walsh function g₄(t), as shown in FIG. 7, would be used, corresponding to the Walsh functions used at the central office 13. The decoded signal is referred to herein as a second decoded-broadband-data signal. The remote-subscriber unit converts the second decoded-broadband data signal to the second broadband-data signal.

In a typical operation, a remote subscriber unit requests a program. In a system having four frequency bands, A, B, C, D, the remote subscribers select programs which are sent to the subscribers as first broadband-data signals in bands A, B, C, D. The next four remote subscribers, which use the same DSL line, select programs which are encoded and sent as second broadband-data signals, etc. Broadband-data signals in the same band, for example, band A, must be encoded using different Walsh functions to provide orthogonality. A television 123 or computer 122 would be used for viewing, after the remote-subscriber unit converts the encoded-broadband-data signal to the decoded broadband-data signal. Thus, for example, four TV sets could be viewing different programs. A fifth TV wants to watch a fifth program. That program is transmitted using a first Walsh encoding signal.

More generally, the improvement to the telephone system includes a central office 13 for encoding a plurality of broadband-data signals. The plurality of broadband-data signals does not include the first set of broadband-data signals. The plurality of broadband-data signals overlays the first set of broadband-data signals within the bandwidth in one of the four or more bands. The encoding typically includes multiplying, or equivalent electronic function, the plurality broadband-data signals by a plurality of encoding signals having a plurality of orthogonal or quasi-orthogonal functions, respectively. Preferably, the plurality of orthogonal functions is from the set of Walsh functions, and at least includes a first Walsh function g₁(t), a second Walsh function g₂(t), a third Walsh function g₃(t), or a fourth Walsh function g₄(t), respectively, as shown in FIG. 7. The resulting plurality of encoded signals is referred to herein as a plurality of encoded-broadband-data signals.

The central office 13 transmits the plurality of encoded-broadband-data signals, at a respective carrier frequency for one of each of the at least four bands, over a DSL-communications channel. The plurality of encoded-broadband signals overlay the first broadband-data signals.

The different bands could get different Walsh functions, rather than say that g₁(t) is used for bands A B, C, D, and g₂(t) is used for second bands A, B, C, D. Perhaps higher order Walsh functions could be reserved for bands B and C, since the higher order Walsh functions can have wider bandwidth, which may result in frequency spillover will be in a neighboring band. In the future, more Walsh functions may be possible to use, since the total bandwidth for a given band may decrease to 0.5 MHz, BT=0.5 MHz and not 1.5 MHz. Current limitations include design of the filters and the distortion caused by filters. A particular filter design is tied into cost of the filter. The use of CDMA means the filter design may be relaxed.

The remote-subscriber unit decodes the plurality of encoded-broadband-data signals. The decoding uses respective replicas of the plurality of the encoding signals having, as used by the central office for encoding, the corresponding plurality of orthogonal or quasi-orthogonal functions. Preferably, the plurality of orthogonal functions includes the first Walsh function g₁(t), second Walsh function g₂(t), third Walsh function g₃(t), or fourth Walsh function g₄(t), respectively, as shown in FIG. 7. The decoding thereby generates a plurality of decoded-broadband-data signals. The remote-subscriber unit converts the plurality of decoded-broadband-data signals to a plurality of received-broadband-data signals, respectively.

FIG. 7 shows the symbols, each with duration T_{S}, and four Walsh functions g₁(t), g₂(t), g₃ (t)₁ g₄(t). Preferably a limited number of Walsh functions would be used, since higher order sequences would require more bandwidth than available. Should more bandwidth become available, then additional Walsh functions can be used. Note that the Walsh functions are orthogonal over the symbol time T_{S}. If, in the limited bandwidth extra Walsh functions were employed, then the signals would distort and the distorted Walsh functions would not remain orthogonal. As a result some attenuation and/or distortion would result, causing a degradation in performance. This degradation might be acceptable under certain conditions.

A signal in band A, chosen to illustrate the concept, includes an in-phase and quadrature-phase component. Both components are required for QAM modulation. Vᵢⱼ(t) is the encoded signal for band i=A and Walsh function j, where in FIG. 7, j=1, 2, 3, 4. Vᵢⱼ(t) is the encoded signal for band I and Walsh function j. There are twenty possible signals that can be sent simultaneously, while in the prior art, it was thought that only four signals could be sent, one in each frequency band. Using the encoding, we effectively are using CDMA to increase system capacity by a factor of five. The following mathematical equations represent the 20 signals, and that the Walsh functions and frequencies are orthogonal over the time Tₛ.

s_{Aj}(t)=I_{A}(t)cos(ω_{A}t)+Q_{A}(t)sin(ω_{A}t) j=1, 2, 3, 4

where j corresponds to the Walsh functions of FIG. 7. ω_{A} is the frequency, in radians per second, of band A.

V_{Aj}(t)=gⱼ(t)s_{Aj}(t) j=1, 2, 3, 4

Vij(t)=gⱼ(t)sᵢⱼ(t) i=A, B, C, D; j=1, 2, 3, 4

$${\int }_{0}^{{T}_{s}} {g}_{j} ( t ) {g}_{k} ( t ) ⅆ t = 1 , j = k ; 0 , j \neq k$$

V(t)=ΣV_{i,j}(t) i=A, B, C, D; j=1, 2, 3, 4

$${\int }_{0}^{{T}_{s}} cos ( {ω}_{i} t ) cos ( {ω}_{p} t ) ⅆ t {T}_{s} / 2 i = p = A , B , C , D ; 0 , i \neq p$$

During the time period 0 to T_{S}, I_{C}(t) and Q_{C}(t) are constant.

The output of the lowpass filter (LPF) can be approximated by the integral, where Walsh functions 1 and 4, and bands C and D, are used as examples:

$${\int }_{0}^{{T}_{s}} {g}_{1} ( t ) {g}_{4} ( t ) cos \{ 2 π ( {f}_{D} - {f}_{C} ) \} ⅆ t = I$$

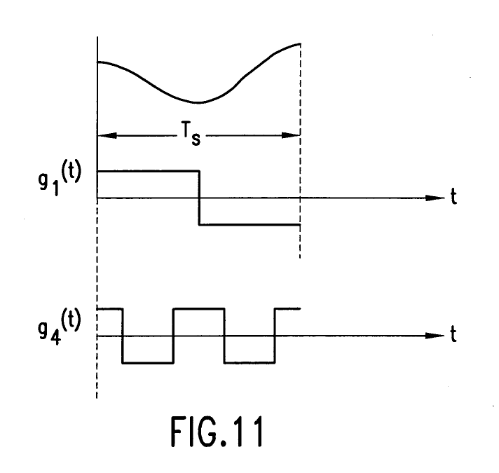

f_{D}−f_{C}=f_{S}, therefore, the integral is over one cycle, as shown in FIG. 11. Due to symmetry, this integral I is equal to zero, regardless of the Walsh functions used.

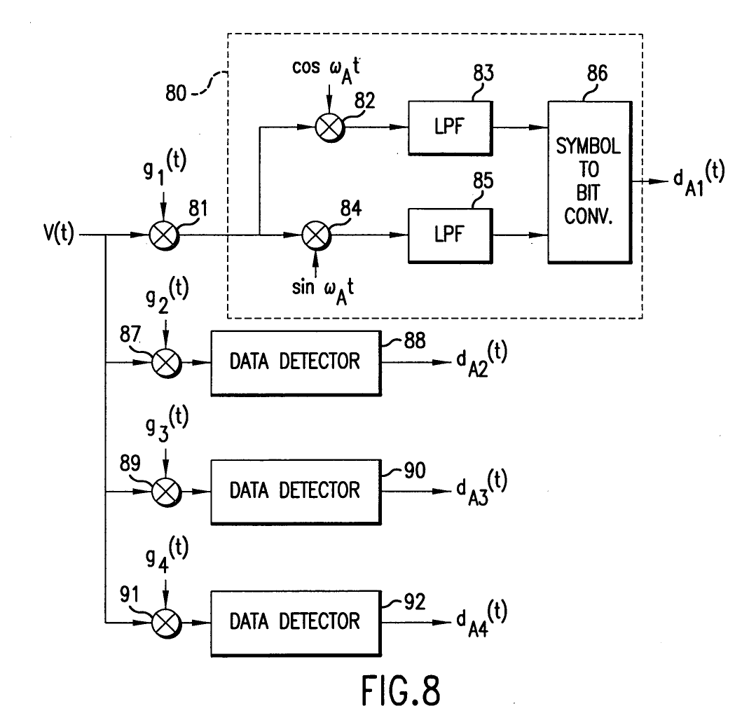

FIG. 8 shows a typical receiver. The receiver uses standard techniques. The receiver is shown for completeness of disclosure. The basic building block of the receiver is shown for frequency A of band A, and the first Walsh function, g₁(t). Similar circuits would be used for other Walsh functions or orthogonal or quasi-orthogonal functions, and frequency bands B, C, D. This embodiment is by way of example, and other embodiments may be designed, using equivalent means and performing the same function. Referring to FIG. 8, a plurality of product devices or mixers 81, 87, 89, 91 multiply the plurality of Walsh functions g₁(t), g₂(t), g₃(t), g₄(t) of FIG. 7. At the outputs of the plurality of mixers 81, 87, 89, 91 is the plurality of decoded-broadband-data signals. A plurality of data detectors 80, 88, 90, 92 converts the plurality of decoded-broadband-data signals to the plurality of received-broadband-data signals, respectively. The order of decoding and converting may be reversed, as is well-known in the art, producing the same result. An example of a data detector 80 includes two mixers 82, 84 for multiplying the respective decoded-broadband-data signal by cos(ω_{A}t) and sin(ω_{A}t), and filtered by lowpass filters 83, 85, respectively, to obtain in-phase and quadrature-phase components of the decoded-broadband-data signal. The in-phase and quadrature-phase components of the decoded-broadband-data signal are converted, as a symbol, to data bits by symbol-to-data-bit converter 86.

Consider multiple remote subscribers are connected to a single DSL line. Today, only four remote subscribers could be connected. Using the present invention, 20 or more could simultaneously be connected. Each remote subscriber who wants to receive a program, requests the program using packet 41 of FIG. 3. The central office receives all of the requests, typically at different times. The central office encodes the broadband-data signal for the requested program, and sends the broadband-data signal to the address in the request. The address preferably includes (1) the telephone number, and (2) the extension of the subscriber. The extension is: (1) the frequency band, which by way of example, may be A, B, C, D, and (2) the Walsh function g₁(t), g₂(t), g₃(t), g₄(t). Thus the telephone determines the DSL line and the band A, B, C, D and Walsh function g₁(t), g₂(t), g₃(t), g₄(t), or g₀(t), determines which of the 20 stations receives the program. Walsh function g₀(t), as used herein, is a constant. A particular frequency band and/or Walsh function may be preassigned to a corresponding set-top box. Alternatively, the frequency band and/or Walsh function, for a set-top box requesting service, may be assigned at the time service is requested, such as for a computer or program for a television. Alternatively, the frequency band and/or Walsh function may be determined from a pool of the available frequency bands and Walsh functions. In the latter case, by way of example, a set-top box requesting service can determine which Walsh functions and frequency bands are in use, and then proceed with an unused frequency band and/or Walsh function, to avoid collisions or interference with other frequency bands and/or Walsh functions in use. The initial set of programs in four frequency bands, prior to using Walsh functions g₁(t), g₂(t), g₃(t), g₄(t), may be considered not to use a Walsh function, or equivalently, a zero order Walsh function g₀(t) which is a constant value.

The decoding process can occur at each remote subscriber set-top boxes 54, 56 and and modem 52, as shown in FIG. 6, or the decoding process can occur at a central set-top box 151 for all subscribers using a particular DSL line. All remote subscribers using the same DSL line have the same telephone number, but have a different extension, can have their respective signals received and decoded in the central set-top box 151. The central set-top box 151 directs the decoded signal to the appropriate extension for the respective subscriber. At the appropriate extension, the signal can be demodulated, decoded and decompressed, so that the appropriate signal can be received and viewed or used.

If a remote subscriber wanted video-on-demand service, then the central office can determine which extensions are in use and then send the video-on-demand signal over all of the extensions that are not in use at that particular time. Thus, if no extensions of the 20 were in use, then a 90-minute program can be downloaded in 4.5 minutes, stored in the subscriber's central set-top box memory, and then streamed to the appropriate extension in real time. See U.S. patent applications having Ser. No. 10/218,990, filed Aug. 14, 2002, and entitled VARIABLE DATA-RATE VIDEO ENTERTAINMENT SYSTEM AND METHOD, by inventor Donald L. Schilling, and U.S. patent application having Ser. No. 10/337,555, filed Jan. 7, 2003, and entitled VIDEO ON DEMAND USING MCMD AND TDM OR FDM, by inventor Donald L. Schilling, which are incorporated herein by reference.

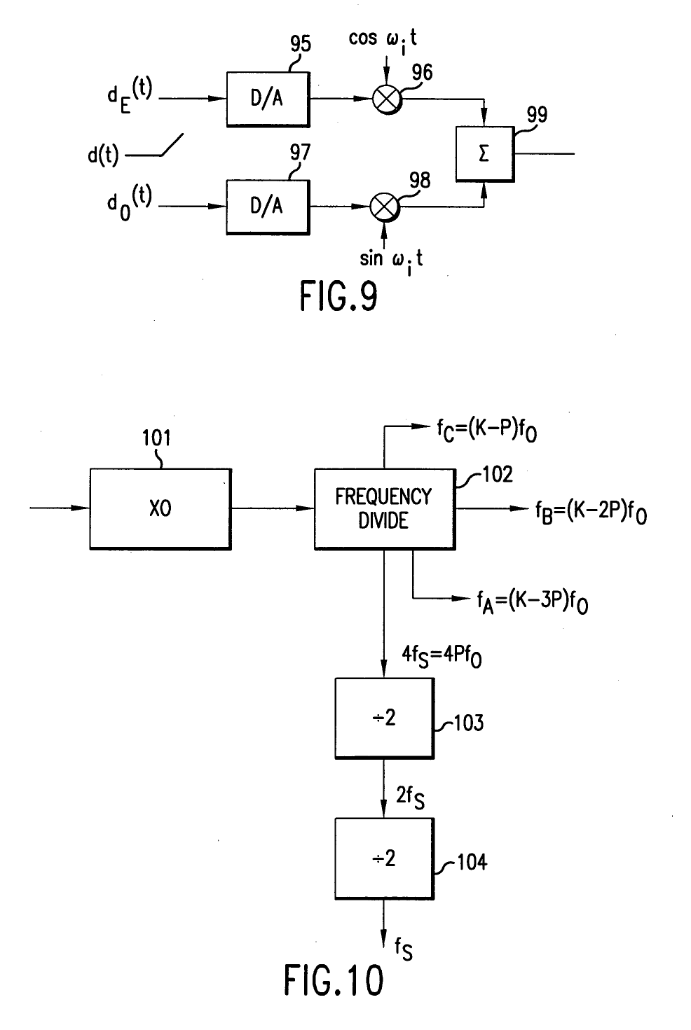

FIG. 9 is a block diagram of QAM generator, as a data to symbol converter. QAM generators are well-known in the art. Data d(t) enter in-phase digital-to-analog converter 95 and quadrature-phase digital-to-analog converter 97. The resulting in-phase signal is multiplied by cos(ωᵢt) and sin(ωᵢt), using in-phase product device 96 and quadrature-phase product device 98, respectively. The outputs of the in-phase product device 96 and quadrature-phase product device 98 are combined by combiner 99, to generate a symbol for transmission over a communications channel, as is well-known in the art.

Preferred operation requires that the Walsh functions be synchronized to the information symbols. This is required to ensure that the average value over a symbol is zero. The preferred approach to synchronization is to synchronize all signals to the carrier frequency, since the carrier frequency can be determined using a voltage-controlled crystal oscillator (VCXO) and a phase locked loop circuit, which is standard in the industry. FIG. 10 shows how synchronization may occur. A block diagram for generating common timing signals is shown. The present invention synchronizes each carrier frequencies f_{A}, f_{B}, f_{C}, and f_{D}, of frequencies bands 23A, B, C, D, with the symbol timing and with four Walsh functions. This is achieved by starting with a crystal oscillator 101, that is a multiple of some basic frequency which is denoted fₒ. All of the frequencies are a multiple of the basic frequency fₒ. The stable oscillator 101, preferably a crystal oscillator, generates a signal which is frequency divided by frequency divider 102 to generate signals at frequencies f_{C}=(K−P)fₒ, f_{B}=(K−2p)fₒ, f_{A}=(K−3P)fₒ, and 4fₛ=4Pfₒ, where fₒ is the frequency of the crystal oscillator. The signal with frequency 4fₛ is divided by divider 103 to obtain a signal with frequency 2fₛ, and further by divider 104 to obtain a signal with frequency f_{S}. These signals can be used at the transmitter and receiver for symbol timing synchronization, encoding signal synchronization, and carrier synchronization.

It will be apparent to those skilled in the art that various modifications can be made to the television via telephone DSL system using spread-spectrum modulation of the instant invention without departing from the scope or spirit of the invention, and it is intended that the present invention cover modifications and variations of the television via telephone system using spread-spectrum modulation provided they come within the scope of the appended claims and their equivalents.

I claim:

1. An improvement to a telephone system using a Digital Subscriber Loop (DSL) having at least one band, with each of the at least one band having a bandwidth, with each band for transmitting a first broadband-data signal, including computer, television, or video signal, comprising the steps of:
encoding a plurality of broadband-data signals, with the plurality of broadband-data signals not including the first broadband-data signal, for overlaying the first broadband-data signal, within the bandwidth in one of the at least one band, by multiplying the plurality broadband-data signals by a plurality of encoding signals having a first Walsh function g₁(t), a second Walsh function g₂(t), a third Walsh function g₃(t), or a fourth Walsh function g₄ (t), respectively, thereby generating a plurality of encoded-broadband-data signals;
transmitting the plurality of encoded-broadband-data signals, at a respective carrier frequency for one of the at least one band, over a DSL-communications channel;
decoding, at a remote-subscriber unit (RSU), the plurality of encoded-broadband-data signals, using respective replicas of the plurality of the encoding signals having, as used for the step of encoding, the corresponding first Walsh function g₁(t), second Walsh function g₂(t), third Walsh function g₃(t), or fourth Walsh function g₄(t), respectively, thereby generating a plurality of decoded-broadband-data signals; and converting, at the remote-subscriber unit, the plurality of decoded-broadband-data signals to a plurality of received-broadband-data signals, respectively.

2. The improvement as set forth in claim 1, further comprising the steps of:
requesting, at the remote-subscriber unit, at the remote subscriber unit, prior to the step of encoding the plurality of broadband-data signals, a plurality of programs which will become the plurality of broadband-data signals; and
viewing, at the remote-subscriber unit, after the step of converting the plurality of decoded-broadband-data signals to the plurality of received-broadband-data signals, the plurality of programs from the plurality of received-broadband-data signals, respectively.

3. An improvement to a telephone system using a Digital Subscriber Loop (DSL) having four or more bands, with each of the four or more bands having a bandwidth, with each band for transmitting a first broadband-data signal, including computer, television, or video signal, comprising the steps of:
encoding a second broadband-data signal, for overlaying the first broadband-data signal, within the bandwidth in one of the four or more bands, by multiplying the second broadband-data signal by an encoding signal having a first Walsh function g₁(t), a second Walsh function g₂(t), a third Walsh function g₃(t), or a fourth Walsh function g₄(t); transmitting, from the the encoded-second broadband-data signal, at a respective carrier frequency for one of the four or more bands, over a DSL-communications channel;
decoding, at a remote-subscriber unit, the encoded-second broadband-data signal, using a respective replica of the encoding signal having, as used for the step of encoding, the corresponding first Walsh function g₁(t), second Walsh function g₂(t), third Walsh function g₃(t), or fourth Walsh function g₄(t), thereby generating a decoded-second broadband-data signal; and
converting, at the remote-subscriber unit, the decoded-second broadband-data signal to the second broadband-data signal.

4. The improvement as set forth in claim 3, further comprising the steps of:
requesting, at the remote-subscriber unit, prior to the step of encoding the second broadband-data signal, a program which will become the second broadband-data signal; and
viewing, at the remote-subscriber unit, after the step of converting the decoded-second broadband-data signal to the second broadband-data signal, the program from the second broadband-data signal.

5. An improvement to a telephone system using a Digital Subscriber Loop (DSL) having at least four bands, with each of the at least four bands having a bandwidth, with each band for transmitting a first broadband-data signal, including computer, television, or video signal, comprising:
a central office for encoding a plurality of broadband-data signals, with the plurality of broadband-data signals not including the first broadband-data signal, for overlaying the first broadband-data signal, within the bandwidth in one of the at least four bands, by multiplying the plurality broadband-data signals by a plurality of encoding signals having a first Walsh function g₁(t), a second Walsh function g₂(t), a third Walsh function g₃(t), or a fourth Walsh function g₄(t), respectively, thereby generating a plurality of encoded-broadband-data signals;
said central office for transmitting the plurality of encoded-broadband-data signals, at a respective carrier frequency for one of the at least four bands, over a DSL-communications channel;
a remote-subscriber unit (RSU) for decoding the plurality of encoded-broadband-data signals, using respective replicas of the plurality of the encoding signals having, as used by said central office for encoding, the corresponding first Walsh function g₁(t), second Walsh function g₂(t), third Walsh function g₃(t), or fourth Walsh function g₄(t), respectively, thereby generating a plurality of decoded-broadband-data signals; and
said remote-subscriber unit for converting the plurality of decoded-broadband-data signals to a plurality of received-broadband-data signals, respectively.

6. The improvement as set forth in claim 5, further comprising:
said remote subscriber unit for requesting at the remote subscriber unit, prior to said central office encoding the plurality of broadband-data signals, a plurality of programs which will become the plurality of broadband-data signals; and
a plurality of any of televisions and computers, for viewing, after the remote-subscriber unit converts the plurality of decoded-broadband-data signals to the plurality of received-broadband-data signals, the plurality of programs from the plurality of received-broadband-data signals, respectively.

7. An improvement to a telephone system using a Digital Subscriber Loop (DSL) having four or more bands, with each of the four or more bands having a bandwidth, with each band for transmitting a first broadband-data signal, including computer, television, or video signal, comprising the steps of:
a central office for encoding a second broadband-data signal, for overlaying the first broadband-data signal, within the bandwidth in one of the four or more bands, by multiplying the second broadband-data signal by an encoding signal having a first Walsh function g₁(t), a second Walsh function g₂(t), a third Walsh function g₃(t), or a fourth Walsh function g₄(t), thereby generating an encoded-broadband-data signal;
said central office for transmitting the encoded-broadband-data signal, at a respective carrier frequency for one of the four or more bands, over a DSL-communications channel;
a remote-subscriber unit for decoding the encoded-second broadband-data signal, using a respective replica of the encoding signal having, as used by said central office for encoding, the corresponding first Walsh function g₁(t), second Walsh function g₂(t), third Walsh function g₃(t), or fourth Walsh function g₄(t), thereby generating a decoded-second broadband-data signal; and
said remote-subscriber unit for converting the decoded-second broadband-data signal to the second broadband-data signal.

8. The improvement as set forth in claim 7, further comprising:
said remote subscriber unit for requesting, prior to said central office encoding the second broadband-data signal, a program which will become the second broadband-data signal; and
a television or computer, for viewing after the remote-subscriber unit converts the decoded-second broadband-data signal to the second broadband-data signal, the program from the second broadband-data signal.

9. An improvement to a telephone system using a Digital Subscriber Loop (DSL) having at least four bands, with each of the at least four bands having a bandwidth, with each band for transmitting a first broadband-data signal, including computer, television, or video signal, comprising the steps of:
encoding a plurality of broadband-data signals, with the plurality of broadband-data signals not including the first broadband-data signal, for overlaying the first broadband-data signal, within the bandwidth in one of the at least four bands, by multiplying the plurality broadband-data signals by a plurality of encoding signals having a plurality orthogonal or quasi-orthogonal functions, respectively, thereby generating a plurality of encoded-broadband-data signals;
transmitting the plurality of encoded-broadband-data signals, at a respective carrier frequency for one of the at least four bands, over a DSL-communications channel;
decoding, at a remote-subscriber unit (RSU), the plurality of encoded-broadband-data signals, using respective replicas of the plurality of the encoding signals having, as used for the step of encoding, the corresponding plurality of orthogonal or quasi-orthogonal functions, respectively, thereby generating a plurality of decoded-broadband-data signals; and
converting, at the remote-subscriber unit, the plurality of decoded-broadband-data signals to a plurality of received-broadband-data signals, respectively.

10. The improvement as set forth in claim 9, further comprising the steps of:
requesting, at the remote-subscriber unit, at the remote subscriber unit, prior to the step of encoding the plurality of broadband-data signals, a plurality of programs which will become the plurality of broadband-data signals; and
viewing, at the remote-subscriber unit, after the step of converting the plurality of decoded-broadband-data signals to the plurality of received-broadband-data signals, the plurality of programs from the plurality of received-broadband-data signals, respectively.

11. An improvement to a telephone system using a Digital Subscriber Loop (DSL) having at least four bands, with each of the at least four bands having a bandwidth, with each band for transmitting a first broadband-data signal, including computer, television, or video signal, comprising:
a central office for encoding a plurality of broadband-data signals, with the plurality of broadband-data signals not including the first broadband-data signal, for overlaying the first broadband-data signal, within the bandwidth in one of the at least four bands, by multiplying the plurality broadband-data signals by a plurality of encoding signals having a plurality of orthogonal or quasi-orthogonal functions, respectively, thereby generating a plurality of encoded-broadband-data signals;
said central office for transmitting the plurality of encoded-broadband-data signals, at a respective carrier frequency for one of the at least four bands, over a DSL-communications channel;
a remote-subscriber unit (RSU) for decoding the plurality of encoded-broadband-data signals, using respective replicas of the plurality of the encoding signals having, as used by said central office for encoding, the corresponding plurality of orthogonal or quasi-orthogonal functions, respectively, thereby generating a plurality of decoded-broadband-data signals; and
said remote-subscriber unit for converting the plurality of decoded-broadband-data signals to a plurality of received-broadband-data signals, respectively.

12. The improvement as set forth in claim 11, further comprising:
said remote subscriber unit for requesting at the remote subscriber unit, prior to said central office encoding the plurality of broadband-data signals, a plurality of programs which will become the plurality of broadband-data signals; and
a plurality of any of televisions and computers, for viewing, after the remote-subscriber unit converts the plurality of decoded-broadband-data signals to the plurality of received-broadband-data signals, the plurality of programs from the plurality of received-broadband-data signals, respectively.

13. An improvement to a telephone system using a Digital Subscriber Loop (DSL) having at least four bands, with each of the at least four bands having a bandwidth, with each band for transmitting a first broadband-data signal, including computer, television, or video signal, comprising:
a central office for encoding a plurality of broadband-data signals, with the plurality of broadband-data signals not including the first broadband-data signal, for overlaying the first broadband-data signal, within the bandwidth in one of the at least four bands, by multiplying the plurality broadband-data signals by a plurality of encoding signals having a plurality of orthogonal or quasi-orthogonal functions, respectively, thereby generating a plurality of encoded-broadband-data signals;
said central office for transmitting the plurality of encoded-broadband-data signals, at a respective carrier frequency for one of the at least four bands, over a DSL-communications channel; and
a central-set-top box, located at a remote subscriber site, for receiving incoming signals, and for decoding the plurality of encoded-broadband-data signals, for a plurality of remote subscribers, using respective replicas of the plurality of the encoding signals having, as used by said central office for encoding, the corresponding plurality of orthogonal or quasi-orthogonal functions, respectively, thereby generating a plurality of decoded-broadband-data signals.

14. The improvement as set forth in claim 13, with a video-on-demand program sent to a remote subscriber using extensions not in use by other subscribers.
